(19) United States
(12) Patent Application Publication
(10) Pub. No.: US 2015/0142963 A1
(43) Pub. Date: May 21, 2015

(54) SMART TERMINAL AND METHOD FOR COLLECTION DATA SUBSCRIPTION

(71) Applicant: Electronics and Telecommunications Research Institute, Daejeon (KR)

(72) Inventors: Jin-Chul CHOI, Daejeon (KR); Dong-Hwan PARK, Daejeon (KR); Hyo-Chan BANG, Daejeon (KR)

(21) Appl. No.: 14/539,647

(22) Filed: Nov. 12, 2014

(30) Foreign Application Priority Data
Nov. 19, 2013 (KR) 10-2013-0140905
Oct. 15, 2014 (KR) 10-2014-0139310

(51) Int. Cl. H04L 12/26; H04L 29/08

(52) U.S. Cl. CPC H04L 43/065; H04L 67/12
USPC 709/224

(57) ABSTRACT

A smart terminal and a method for subscribing to collection data are disclosed. The smart terminal in accordance with an embodiment of the present invention includes: a main application configured to make a data collection request; a plurality of subscription applications configured to subscribe to collection data being collected according to the data collection request made by the main application; a gateway module configured to perform communication with an internal/external device, request a target device in the internal/external device for data collection according to the data collection request made by the main application, and receive a collection data report from the target device if the target device collects the collection data; and a data hub configured to have the collection data report transferred thereto from the gateway module and provide the collection data to the subscription applications.

### CROSS-REFERENCE TO RELATED APPLICATIONS

This application claims the benefit of Korean Patent Application No. 10-2013-0140905, filed with the Korean Intellectual Property Office on Nov. 19, 2013, the disclosure of which is incorporated herein by reference in its entirety.

### BACKGROUND

1. Technical Field

The present invention relates to a smart terminal and a method for performing collection data subscription.

2. Background Art

With an increased popularity of portable smart terminals, such as smartphones and smart pads, introduced to the markets are a variety of IoT (Internet of Things) products and services utilizing short-distance communication technologies (e.g., Bluetooth, USB, WiFi-Direct, NFC, etc.) installed in the smartphones. Particularly, there has been an increased demand for services focused on users, to whom the IoT services are provided at any time and anywhere, no focused on suppliers. Moreover, as many IT businesses actively develop new smart terminals in order to lead the post-smartphone era, a new demand for increased utility of the smart terminals is also on the rise.

In the case of the conventional IoT sensors and drivers utilizing the smart terminals, the sensing data and driver operation information was generally allowed to be utilized through manufacturer-provided applications only. Moreover, the conventional IoT sensor and drivers have an exclusive property of not sharing data with other applications within the smart terminal or with other platforms.

There have been new movements recently for utilizing the smart terminal as a gateway for IoT services, and accordingly the smart terminal needs to process data collected from IoT devices, other application services need to be able to use the processed data.

### SUMMARY

The present invention provides a smart terminal and a method for performing collection data subscription that can allow data collected by an IoT sensor and driver worn by an individual or installed around the individual to be shared by multiple applications within the smart terminal.

An aspect of the present invention features a smart terminal.

The smart terminal in accordance with an embodiment of the present invention includes: a main application configured to make a data collection request; a plurality of subscription applications configured to subscribe to collection data being collected according to the data collection request made by the main application; a gateway module configured to perform communication with an internal/external device, request a target device in the internal/external device for data collection according to the data collection request made by the main application, and receive a collection data report from the target device if the target device collects the collection data; and a data hub configured to have the collection data report transferred thereto from the gateway module and provide the collection data to the subscription applications.

The internal/external device may be an Internet of Things (IoT) sensor or a driver configured to collect data for an IoT service and placed inside or outside the smart terminal.

The gateway module may include: a communication manager configured to perform communication with the internal/external device; an application administrator configured to check whether the main application has an authorization for control and inquiry to the target device once the data collection request is received from the main application, and to transfer the data collection request if the main application has the authorization; a device manager configure to store information on the internal/external device; a request manager configured to send an inquiry to the device manager about whether the target device can process the data collection request once the data collection request is received, request the data hub for creation or modification of a subscription group for the collection data if the target device can process the data collection request, and transmit the data collection request to the target device through the communication manager; and a report manager configured to transfer the collection data report received from the target device to the data hub through the communication manager.

The data hub may include: a subscription group including the collection data and metadata and access privilege information of the collection data; a subscription group manager configured to manage signing up for membership and cancelation of membership of the subscription application with the subscription group; an input manager configured to create or modify the subscription group according to the request for creation or modification of the subscription group, receive the collection data report and transfer the collection data report to a pertinent subscription group; and an output manager configured to transfer the collection data received from the subscription group to the main application and the subscribed subscription application.

The subscription group may be configured to transfer a request for collection data to the output manager, the request for collection data comprising the collection data, an ID of the main application and an ID of the subscribed subscription application.

The collection data report may include collection data and a subscription group ID, and the input manager may be configured to transfer the collection data report to the pertinent subscription group by referring to the subscription group ID.

Once a request for signing up for membership with a subscription group that can provide desired data is received from the subscription application, the subscription group manager may be configured to compare requirements information included in the request for signing up with specification information of the subscription group, and if it is determined that data can be provided, an ID of the subscription application may be bound to the subscription group containing the data desired to be provided, and a processing result with the ID of the subscription group included therein may be transferred to the subscription application.

The requirements information may include type information and access privilege information of the data to be provided, and the subscription group manager may determine that data can be provided if the specification information satisfies the requirements information when data type information and access privilege information included in the requirements information are compared with data type information and access privilege information included in the specification information.

In case the collection data is received through the input manager, the subscription group may be configured to generate a message object including the collection data and transfer the generated message object to the main application and the subscribed subscription application through the output manager.

If the subscribed subscription application requires that no more collection data be provided thereto, the second subscription application may request the subscription group manager for cancelation of membership, and the pertinent subscription group may unbind an ID of the subscribed subscription application so that no more collection data is provided.

Another aspect of the present invention features a method for subscribing to collection data by a main application and a subscription application in a smart terminal.

The method for subscribing to collection data by a main application and a subscription application in a smart terminal in accordance with an embodiment of the present invention includes: making a data collection request, the data collection request being made by the main application; requesting a target device in an internal/external device for data collection according to the data collection request made by the main application, the data collection being requested by a gateway module of the smart terminal; receiving a collection data report from the target device once the target device collects the collection data, the collection data report being received by the gateway module; and receiving the collection data report from the gateway module and providing the collection data to the subscription application, the collection data report being received and the collection data being provided by a data hub of the smart terminal.

The method may further include, after making the data collection request by the main application: checking whether the main application has an authorization for control and inquiry to the target device, the checking being performed by the gateway module; inquiring about whether the target device can process the data collection request if the main application has the authorization, the inquiring being performed by the gateway module; and requesting the data hub for creation or modification of a subscription group for the collection data if the target device can process the data collection request, the requesting being performed by the gateway module.

The method may further include: transferring a subscription request including an ID of the subscription application and subscription data type information to the data hub, the subscription request being transferred by the subscription application; transferring a subscription application addition request including the ID of the subscription application to a subscription group satisfying the subscription data type information according to the subscription request, the subscription application addition request being transferred by the data hub; binding the ID of the subscription application to a subscription list, the ID of the subscription application being bound by the subscription group; and transferring a reply including a processing result for the subscription request to the subscription application, the reply being transferred by the data hub.

The method may further include: transferring a subscription cancelation request including the ID of the subscription application and an ID of a subscribed subscription group to the data hub, the subscription cancelation request being transferred by the subscription application; transferring a subscription application cancelation request including the ID of the subscription application to the subscribed subscription group, the subscription application cancelation request being transferred by the data hub; unbinding the ID of the subscription application from a subscription list, the ID of the subscription application being unbound by the subscription group; and transferring a reply including a processing result for the subscription cancelation request to the subscription application, the reply being transferred by the data hub.

The step of requesting a target device for data collection may include transferring a data collection request including a subscription group ID, an ID of the target device and specification information of collection data to the internal/external device, the data collection request being transferred by the gateway module.

The method may further include, after the step of requesting a target device for data collection, transferring reply information to the main application if a reply to the data collection request is received, the reply information comprising a subscription group ID and information on whether the data collection request is processed, the reply information being transferred by the gateway module.

According to the smart terminal and the method for performing collection data subscription in accordance with an embodiment of the present invention, processing data of a smart terminal-based IoT sensor and driver can be readily collected, accessed and utilized by applications in the smart terminal.

### BRIEF DESCRIPTION OF THE DRAWINGS

FIG. 1 shows a brief configuration of a smart terminal in accordance with an embodiment of the present invention.

FIG. 2 shows a brief configuration of a gateway module and a data hub.

FIG. 3 illustrates an operation between the data hub and subscription applications.

FIG. 4 is a flow diagram showing how a subscription application signs up for membership to a subscription group.

FIG. 5 is a flow diagram showing how the subscription application cancels membership to the subscription group.

FIG. 6 is a flow diagram showing a method for performing collection data subscription in a smart terminal in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain technology is determined to evade the point of the present invention, the pertinent detailed description will be omitted. Numerals (e.g., first, second, etc.) used in the description of the present invention are only for distinguishing one element from another element.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

Hereinafter, some embodiments will be described in detail with reference to the accompanying drawings. Identical or corresponding elements will be given the same reference numerals, regardless of the figure number, and any redundant description of the identical or corresponding elements will not be repeated. Throughout the description of the present invention, when describing a certain technology is determined to evade the point of the present invention, the pertinent detailed description will be omitted.

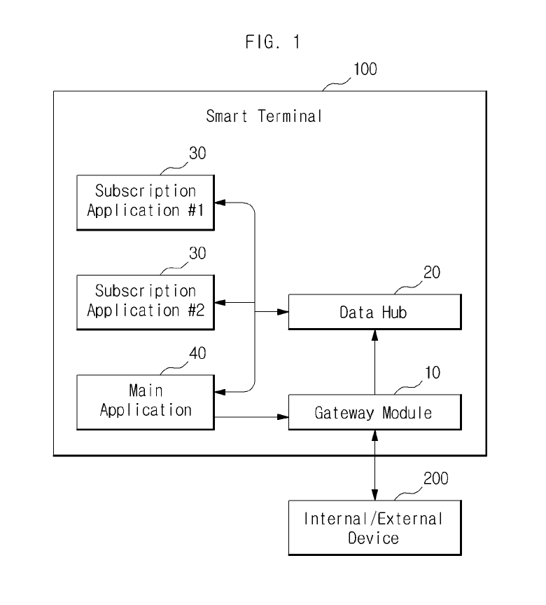

FIG. 1 shows a brief configuration of a smart terminal in accordance with an embodiment of the present invention.

Referring to FIG. 1, a smart terminal 100 in accordance with an embodiment of the present invention includes a gateway module 10, a data hub 20, a plurality of subscription applications 30 and a main application 40.

An internal/external device 200 may collect data for an Internet of Things (IoT) service and be placed inside or outside the smart terminal 100. For instance, the internal/external device 200 may be an IoT sensor or driver that is carried or worn by an individual or installed around the individual, and collect sensing data or processing data pursuant to an operation of the driver.

The main application 40 transmits a data collection request to the internal/external device 200 through the gateway module 10. Then, a target device in the internal/external device 200 that has the data collection request transferred thereto may collect data. Hereinafter, such collected data will be referred to as collection data.

The subscription applications 30 subscribes the collection data collected according to the request of the main application 40.

The gateway module 10 is responsible for communication with the internal/external device 200 and processes a request made by the main application 40.

The data hub 20 provides the collection data collected from the internal/external device 200 to a subscription application 30 among the plurality of subscription applications 30 that is approved for subscription of the collection data.

For example, once the main application 40 requests the gateway module 10 for data collection about the internal/external device 200, the gateway module 10 transfers a data collection request to a pertinent device of the internal/external device 200. Then, once the internal/external device 200 collects the collection data according to the data collection request, the gateway module 10 receives a collection data report from the internal/external device 200 and transfers the received collection data report to the data hub 20. Thereafter, by receiving and approving a collection data subscription request from the plurality of subscription applications 30, the data hub 20 generates and manages a subscription group and provides the collection data to the subscription application 30, of which collection data subscription is approved according to subscription request steps.

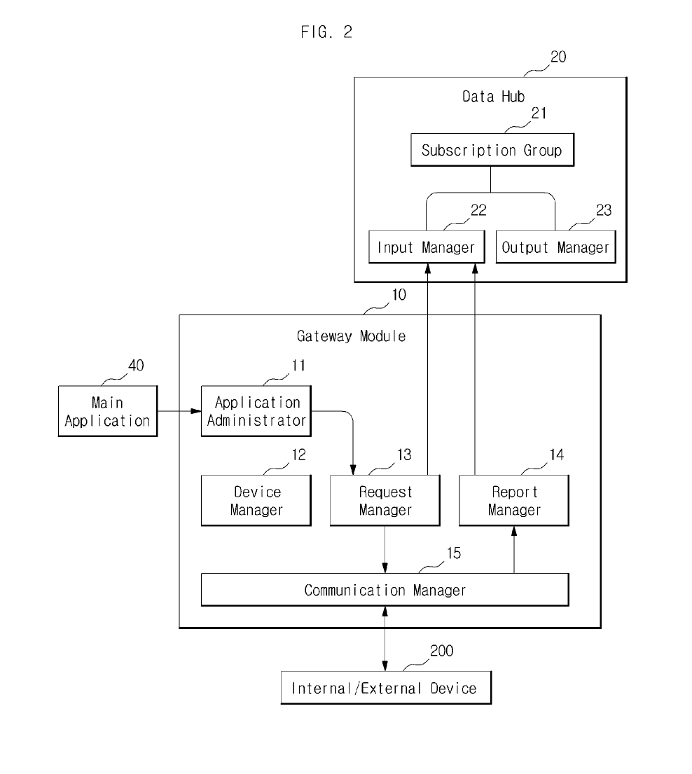

FIG. 2 shows a brief configuration of the gateway module and the data hub.

Referring to FIG. 2, the gateway module 10 includes an application administrator 11, a device manager 12, a report manager 14 and a communication manager 15, and the data hub 20 includes a subscription group 21, an input manager 22 and an output manager 23.

The gateway module 10 controls the internal/external device 200 or receives the data collected by the internal/external device 200, pursuant to a request made by the main application 40. In other words, the gateway module 10 receives the collection data report including the collection data from the internal/external device 200 and transfers the collected collection data report to the input manager 22 of the data hub 20.

The request manager 13 of the gateway module 10 analyzes the request made by the main application 40 and performs inquiry or control for the internal/external device 200 through the communication manager 15. Moreover, the request manager 13 has a function of transferring a request for generation of a subscription group, which includes specification information such as metadata and access privilege information of the collection data, to the input manager 22 or transferring a request for change or deletion of specification information of a pre-existing subscription group.

The report manager 14 of the gateway module 10 has a function of providing the collection data, which is collected from the internal/external device 200 through the communication manager 15, to the pertinent subscription group through the input manager 22.

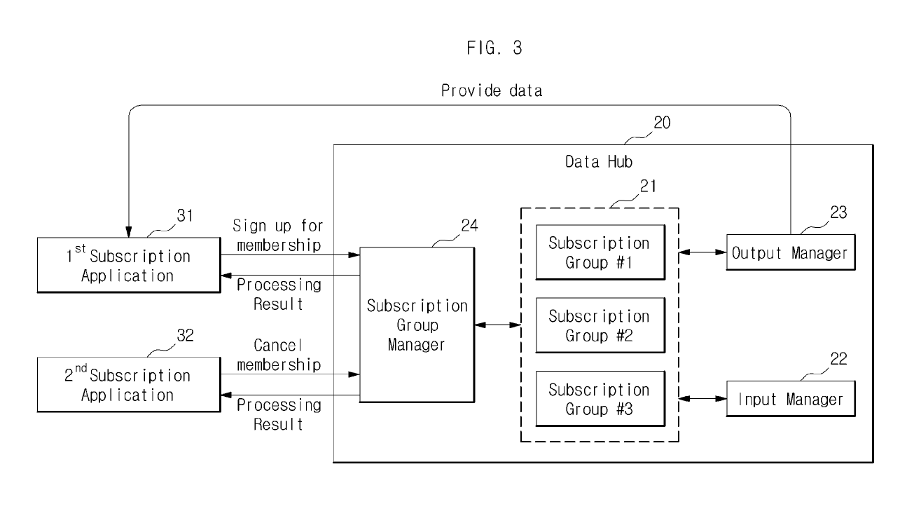

FIG. 3 illustrates an operation between the data hub and the subscription applications.

Referring to FIG. 3, a first subscription application 31 transfers a request for signing up for membership with a subscription group 21 that can provide desired data to a subscription group manager 24 of the data hub 20. Here, the request may include requirements information. For example, the request for signing up for membership may include type information, access privilege information and the like of data desired to be provided. Then, the subscription group manager 24 compares the requirements information of the first subscription application 31 with the specification information of the subscription groups 21 generated by the main application 40. In other words, the subscription group manager 24 may compare data type information and access privilege information included in the requirements information with data type information and access privilege information included in the specification information. Then, in case, as a result of the comparison, it is determined that the specification information satisfies the requirements information and thus it is possible to provide the data, an ID of the first subscription application 31 is bound to the subscription group 21 having the pertinent data included therein, and a processing result with an ID of the subscription group 21 included therein is transferred to the first subscription application 31. Afterwards, in case the collection data is received through the input manager 22, each of the subscription groups 21 generates a message object including the collection data and transfers the generated message object through the output manager 23 to the main application 40 and the first subscription application 31 that is signed up for membership.

If a second subscription application 32 requires that no more collection data be provided thereto, the second subscription application 32 requests the subscription group manager 24 for cancelation of membership, and the pertinent subscription group 21 unbinds an ID of the second subscription application 32 so that no more collection data is provided to the second subscription application 32.

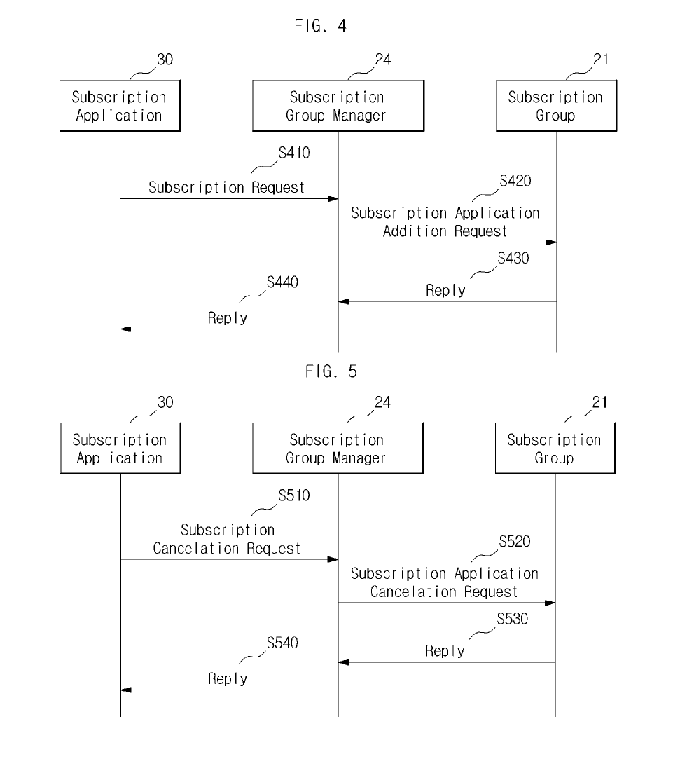

FIG. 4 is a flow diagram showing how a subscription application signs up for membership to a subscription group.

In step S410, a subscription application 30 that desires to subscribe to data transfers a subscription request, which includes an ID of the subscription application 30 and subscription data type information, to a subscription group manager 24.

In step S420, the subscription group manager 24 transfers a subscription application addition request, which includes the ID of the subscription application 30, to a subscription group 21 that satisfies the subscription data type information, according to the subscription request.

In step S430, the subscription group 21 binds the ID of the pertinent subscription application 30 to a subscription list and transfers a reply, which includes the ID of the pertinent subscription group 21, to the subscription group manager 24.

In step S440, the subscription group manager 24 transfers the received reply to the subscription application 30 and terminates the procedures for signing up for subscription group.

FIG. 5 is a flow diagram showing how the subscription application cancels membership to the subscription group.

In step S510, a subscription application 30 requesting for cancelation of membership to a subscription group 21 transfers a subscription cancelation request, which includes an ID of the subscription application 30 and an ID of the subscription group 21 being subscribed to, to a subscription group manager 24.

In step S520, the subscription group manager 24 transfers a subscription application cancelation request to the pertinent subscription group 21.

In step S530, the subscription group 21 unbinds an ID of the pertinent subscription application 30 in a subscription list and transfers a reply, including a processing result of unbinding, to the subscription group manager 24.

In step S540, the subscription group manager 24 transfers the received reply to the subscription application 30 and terminates the procedures for cancelation of membership to subscription group.

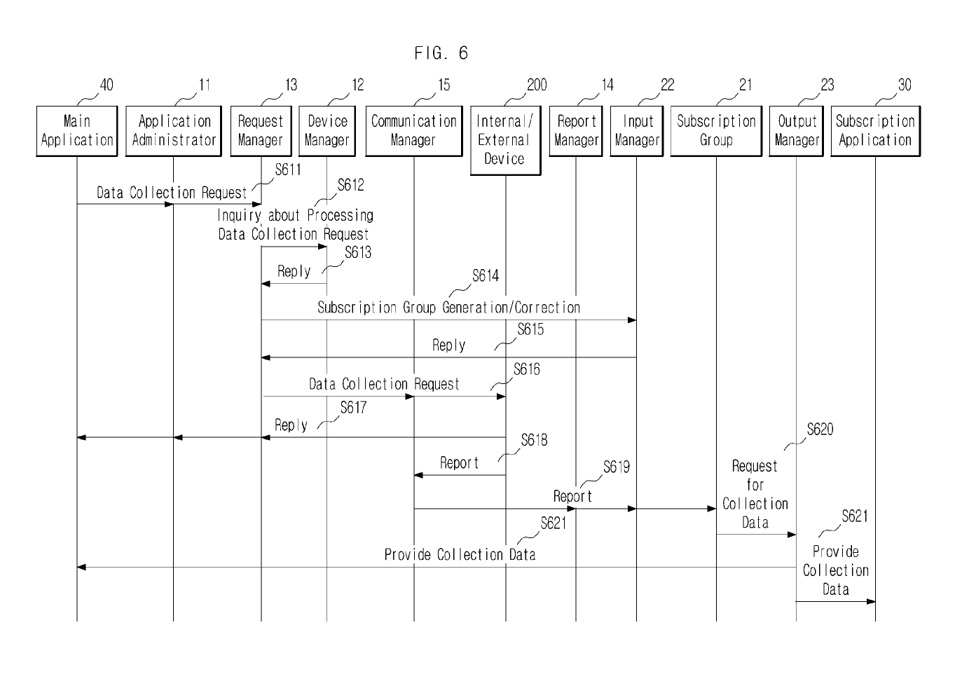

FIG. 6 is a flow diagram showing a method for performing collection data subscription in a smart terminal in accordance with an embodiment of the present invention.

In step S611, once a main application 40 requests an application administrator 11 for data collection, the application administrator 11 checks whether the main application 40 has an authorization for control and inquiry to an internal/external device 200, and transfers a data collection request to a request manager 13 if the main application 40 has the authorization.

In step S612, the request manager 13 sends an inquiry to a device manager 12 about whether the targeted internal/external device 200 can process the data collection request.

In step S613, the request manager 13 receives a reply from the device manager 12 regarding whether the targeted internal/external device 200 can process the data collection request.

In step S614, in case the targeted internal/external device 200 can process the data collection request made by the main application 40, the request manager 13 transfers a request for subscription group generation for the collected data or a request for modification of specification of a pre-existing subscription group 21 to an input manager 22.

In step S615, the input manager 22 transfer a reply to the request for generation and/or modification of the subscription group 21 to the request manager 13.

In step S616, the request manager 13 transfers the data collection request made by the main application 40 to the internal/external device 200 through a communication manager 15. Here, the data collection request may include a subscription group ID, an ID of the targeted internal/external device 200 and specification information of collection data.

In step S617, once a reply to the data collection request is received from the internal/external device 200, the request manager 13 transfers reply information, which includes the subscription group ID and information on whether the request can be processed, to the main application 40 through the application administrator 11.

In step S618, the internal/external device 200 transfers a collection data report, which includes the collection data and the subscription group ID, to the communication manager 15.

In step S619, the communication manager 15 transfers the collection data report to a report manager 14, which then transfers the collection data report to the input manager 22 of a data hub 20, and the input manager 22 transfers the collection data report to a pertinent subscription group 21 by referring to the subscription group ID included in the collection data report.

In step S620, the subscription group 21 transfers a request for collection data that includes the collection data, an ID of the main application 40 and an ID of the subscription application 30, to an output manager 23.

In step S621, the output manager 23 transfers the collection data to the main application 40 and the subscribed subscription application 30.

The method for performing collection data subscription according to an embodiment of the present invention may be implemented as a form of program instructions executable through various means for electronically processing information and written in a storage medium, which may include program instructions, data files, data structures or any combination thereof.

The program instructions stored in the storage medium can be designed and configured specifically for the present invention or can be publically known and available to those who are skilled in the field of software. Examples of the storage medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above hardware devices can be configured to operate as one or more software modules in order to perform the operation of the present invention, and the opposite is also possible.

While the present invention has been described with reference to certain embodiments, the embodiments are for illustrative purposes only and shall not limit the invention. It is to be appreciated that those skilled in the art can change or modify the embodiments without departing from the scope and spirit of the invention.

What is claimed is:

1. A smart terminal comprising:
a main application configured to make a data collection request;
a plurality of subscription applications configured to subscribe to collection data being collected according to the data collection request made by the main application;
a gateway module configured to perform communication with an internal/external device, request a target device in the internal/external device for data collection according to the data collection request made by the main application, and receive a collection data report from the target device if the target device collects the collection data; and
a data hub configured to have the collection data report transferred thereto from the gateway module and provide the collection data to the subscription applications.

2. The smart terminal of claim 1, wherein the internal/external device is an Internet of Things (IoT) sensor or a driver configured to collect data for an IoT service and placed inside or outside the smart terminal.

3. The smart terminal of claim 1, wherein the gateway module comprises:
a communication manager configured to perform communication with the internal/external device;
an application administrator configured to check whether the main application has an authorization for control and inquiry to the target device once the data collection request is received from the main application, and to transfer the data collection request if the main application has the authorization;
a device manager configure to store information on the internal/external device;
a request manager configured to send an inquiry to the device manager about whether the target device can process the data collection request once the data collection request is received, request the data hub for creation or modification of a subscription group for the collection data if the target device can process the data collection request, and transmit the data collection request to the target device through the communication manager; and
a report manager configured to transfer the collection data report received from the target device to the data hub through the communication manager.

4. The smart terminal of claim 3, wherein the data hub comprises:
a subscription group comprising the collection data and metadata and access privilege information of the collection data;
a subscription group manager configured to manage signing up for membership and cancelation of membership of the subscription application with the subscription group;
an input manager configured to create or modify the subscription group according to the request for creation or modification of the subscription group, receive the collection data report and transfer the collection data report to a pertinent subscription group; and
an output manager configured to transfer the collection data received from the subscription group to the main application and the subscribed subscription application.

5. The smart terminal of claim 4, wherein the subscription group is configured to transfer a request for collection data to the output manager, the request for collection data comprising the collection data, an ID of the main application and an ID of the subscribed subscription application.

6. The smart terminal of claim 4, wherein the collection data report comprises collection data and a subscription group ID, and
wherein the input manager is configured to transfer the collection data report to the pertinent subscription group by referring to the subscription group ID.

7. The smart terminal of claim 4, wherein, once a request for signing up for membership with a subscription group that can provide desired data is received from the subscription application, the subscription group manager is configured to compare requirements information included in the request for signing up with specification information of the subscription group, and if it is determined that data can be provided, an ID of the subscription application is bound to the subscription group containing the data desired to be provided, and a processing result with the ID of the subscription group included therein is transferred to the subscription application.

8. The smart terminal of claim 7, wherein the requirements information comprises type information and access privilege information of the data to be provided, and
wherein the subscription group manager determines that data can be provided if the specification information satisfies the requirements information when data type information and access privilege information included in the requirements information are compared with data type information and access privilege information included in the specification information.

9. The smart terminal of claim 7, wherein, in case the collection data is received through the input manager, the subscription group is configured to generate a message object including the collection data and transfer the generated message object to the main application and the subscribed subscription application through the output manager.

10. The smart terminal of claim 7, wherein, if the subscribed subscription application requires that no more collection data be provided thereto, the second subscription application requests the subscription group manager for cancelation of membership, and the pertinent subscription group unbinds an ID of the subscribed subscription application so that no more collection data is provided.

11. A method for subscribing to collection data by a main application and a subscription application in a smart terminal, the method comprising:
making a data collection request, the data collection request being made by the main application;
requesting a target device in an internal/external device for data collection according to the data collection request made by the main application, the data collection being requested by a gateway module of the smart terminal;
receiving a collection data report from the target device once the target device collects the collection data, the collection data report being received by the gateway module; and
receiving the collection data report from the gateway module and providing the collection data to the subscription application, the collection data report being received and the collection data being provided by a data hub of the smart terminal.

12. The method of claim 11, further comprising, after making the data collection request by the main application:
checking whether the main application has an authorization for control and inquiry to the target device, the checking being performed by the gateway module;
inquiring about whether the target device can process the data collection request if the main application has the authorization, the inquiring being performed by the gateway module; and
requesting the data hub for creation or modification of a subscription group for the collection data if the target device can process the data collection request, the requesting being performed by the gateway module.

13. The method of claim 11, further comprising:
transferring a subscription request including an ID of the subscription application and subscription data type information to the data hub, the subscription request being transferred by the subscription application;
transferring a subscription application addition request including the ID of the subscription application to a subscription group satisfying the subscription data type information according to the subscription request, the subscription application addition request being transferred by the data hub;
binding the ID of the subscription application to a subscription list, the ID of the subscription application being bound by the subscription group; and
transferring a reply including a processing result for the subscription request to the subscription application, the reply being transferred by the data hub.

14. The method of claim 11, further comprising:
transferring a subscription cancelation request including the ID of the subscription application and an ID of a subscribed subscription group to the data hub, the subscription cancelation request being transferred by the subscription application;
transferring a subscription application cancelation request including the ID of the subscription application to the subscribed subscription group, the subscription application cancelation request being transferred by the data hub;
unbinding the ID of the subscription application from a subscription list, the ID of the subscription application being unbound by the subscription group; and
transferring a reply including a processing result for the subscription cancelation request to the subscription application, the reply being transferred by the data hub.

15. The method of claim 11, wherein the step of requesting a target device for data collection comprises transferring a data collection request including a subscription group ID, an ID of the target device and specification information of collection data to the internal/external device, the data collection request being transferred by the gateway module.

16. The method of claim 11, further comprising, after the step of requesting a target device for data collection, transferring reply information to the main application if a reply to the data collection request is received, the reply information comprising a subscription group ID and information on whether the data collection request is processed, the reply information being transferred by the gateway module.
